(19) United States
(12) Patent Application Publication
(10) Pub. No.: US 2023/0274133 A1
(43) Pub. Date: Aug. 31, 2023

(54) LEARNING METHOD, LEARNING APPARATUS AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 18/013,237

(22) PCT Filed: Jul. 6, 2020
(86) PCT No.: PCT/JP2020/026435

§ 371 Date: Dec. 27, 2022

(51) Int. Cl. G06N 3/08; G06N 3/045

(52) U.S. Cl. CPC G06N 3/08; G06N 3/045

(57) ABSTRACT

A learning method includes: receiving as input a set of data sets {D₁, . . . , D_{T}} wherein Dₜ for a task tin a task set {1, . . . , T} includes feature amount vectors of cases of t; sampling t from the task set, and sampling a first subset from Dₜ and a second subset from Dₜ excluding the first subset; generating a task vector representing a property oft corresponding to the first subset by a first neural network; nonlinearly transforming feature amount vectors included in data included in the second subset by a second neural network using the task vector; calculating scores representing degrees of anomaly of the feature amount vectors using the transformed feature amount vectors and a preset center vector; and learning parameters of the first and second neural networks so as to make an index value representing generalized performance of anomaly detection higher using the scores.

### TECHNICAL FIELD

The present invention relates to a learning method, a learning apparatus, and a program.

### BACKGROUND ART

An anomaly detection method normally executes learning of a model by using a task-specific training data set. While a large amount of training data sets is required to achieve high performance, there is an issue that a high cost is required to prepare a sufficient amount of training data for each task.

In order to solve this issue, a meta-learning method for achieving high performance even using a small amount of training data by utilizing training data of different tasks has been proposed (for example, Non Patent Literature 1).

### PRIOR ART LITERATURE

### Non Patent Literature

Non Patent Literature 1 Finn, Chelsea, Pieter Abbeel, and Sergey Levine. “Model-agnostic meta-learning for fast adaptation of deep networks.” Proceedings of the 34th International Conference on Machine Learning, 2017.

### SUMMARY OF INVENTION

### Technical Problem

However, the existing meta-learning method has an issue that sufficient performance cannot be achieved.

One embodiment of the present invention has been made in view of the above point, and an object thereof is to learn a high-performance anomaly detection model.

### Solution to Problem

In order to achieve the above object, a learning method executed by a computer, the learning method includes:

an input step of receiving as input a set of data sets D={D₁, . . . , D_{T}} wherein a task set is {1, . . . , T} and a data set including data at least including feature amount vectors representing features of cases of a task t∈{1, . . . , T} is denoted as Dₜ;

a sampling step of sampling a task t from the task set {1, . . . , T}, and sampling a first subset from a data set Dₜ of the task t and a second subset from a set obtained by excluding the first subset from the data set Dₜ;

a generation step of generating a task vector representing a property of the task t corresponding to the first subset by a first neural network;

a conversion step of nonlinearly transforming feature amount vectors included in data included in the second subset by a second neural network using the task vector;

a score calculation step of calculating scores representing respective degrees of anomaly of the feature amount vectors using the nonlinearly transformed feature amount vectors and a preset center vector; and

a learning step of learning a parameter of the first neural network and a parameter of the second neural network so as to make an index value representing generalized performance of anomaly detection higher using the scores.

### Advantageous Effects of Invention

A high-performance anomaly detection model can be learned.

### BRIEF DESCRIPTION OF DRAWINGS

FIG. 1 is a diagram illustrating an example of a functional configuration of a learning apparatus according to a present embodiment.

FIG. 2 is a flowchart illustrating an example of a flow of learning processing according to the present embodiment.

FIG. 3 is a diagram illustrating an example of a hardware configuration of the learning apparatus according to the present embodiment.

### DESCRIPTION OF EMBODIMENTS

Hereinafter, one embodiment of the present invention will be described. In the present embodiment, a learning apparatus 10 capable of learning a model by which anomaly detection can be performed even in a case where only a small amount of data is given in a target task, when a set of data sets for a plurality of types of anomaly detection (that is, a plurality of anomaly detection tasks) is given as a training data set will be described.

To the learning apparatus 10 according to the present embodiment, it is assumed that the following set of T data sets Dₜ is given in learning.

{ [symbol] ₜ}ₜ₌₁^{T} [Math. 1]

Hereinafter, this set of T data sets Dₜ is also referred to as a “set D of training data sets”. That is, D={D₁, . . . , D_{T}}. Here, it is assumed that Dₜ =(xₜₙ,yₜₙ) is a data set of a task t, xₜₙ is a feature amount vector of an n-th case of the task t, yₜₙ is a label representing whether the case is anomalous, and set as yₜₙ=1 if anomalous, or yₜₙ=0 if normal. However, the label yₜₙ may not be given to the feature amount vector xₜₙ. Note that the case is a target of anomaly detection.

In testing (alternatively, in practical operation of an anomaly detection model, or the like), it is assumed that a set of a small amount of data in a target task S={(xₙ,yₙ)} is given. Hereinafter, such a set of a small amount of data in a target task S is also referred to as a “support set”. A goal of the learning apparatus 10 is to learn an anomaly detection model by which whether feature amount vectors x having unknown anomaly labels in the target task (the feature amount vectors x are also referred to as a “queries”) are anomalous is determined when the feature amount vectors x are given. In other words, a goal of the learning apparatus 10 is to learn a model by which labels (alternatively, response variables in a case where the feature amount vectors x are regarded as explanatory variables) y for the feature amount vectors x are more accurately predicted.

Note that, in the present embodiment, data (that is, data representing a feature amount vector xₙ or data representing a pair of the feature amount vector xₙ and its label yₙ) is represented in a vector format such as an image or a graph, but in a case where the data is not in a vector format, the present embodiment can be similarly applied by converting the data into data represented in a vector format. Furthermore, the present embodiment will be mainly described assuming anomaly detection, but is not limited thereto, and can be similarly applied to, for example, outlier detection, a binary classification problem, and the like.

### Functional Configuration

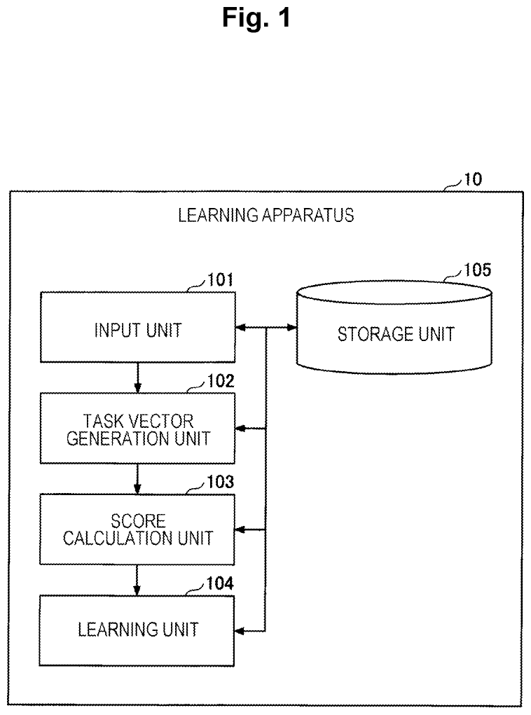

First, a functional configuration of the learning apparatus 10 according to the present embodiment will be described with reference to FIG. 1. FIG. 1 is a diagram illustrating an example of the functional configuration of the learning apparatus 10 according to the present embodiment.

As illustrated in FIG. 1, the learning apparatus 10 according to the present embodiment includes an input unit 101, a task vector generation unit 102, a score calculation unit 103, a learning unit 104, and a storage unit 105.

The storage unit 105 stores a set D of training data sets, a parameter to be learned, and the like.

The input unit 101 receives as input the set D of training data sets stored in the storage unit 105 in learning. Note that, in testing, the input unit 101 receives as input a support set S of a target task and feature amount vectors x of an anomaly detection target.

Here, in learning, after a task t is sampled from a task set {1, . . . , T} by the learning unit 104, a support set S and a query set Q are sampled from a data set Dₜ. The support set S is a support set used in learning (that is, a data set including a small amount of data (pairs of a feature amount vector and a label) in the sampled task t), and the query set Q is a set of queries used in learning. Note that the feature amount vectors x included in the query set Q are associated with the respective labels y (that is, the query set Q is a set of pairs of a feature amount vector and its label in the task t).

The task vector generation unit 102 generates a task vector representing a property of a task corresponding to a support set using the support set.

It is assumed that a support set of a certain task (that is, a set of pairs of a feature amount vector of the task and its label) is as follows:

S={(xₙ, [symbol] ₙ)}ₙ₌₁^{N}^{_{S}} [Math. 2]

where N_{S} is a size of the support set.

At this time, the task vector generation unit 102 generates a task vector r representing the feature of the task corresponding to the support set S by a neural network. For example, the task vector generation unit 102 can generate the task vector r by following Expression (1):

$$[ Math . 3 ]$$

$$r = g ( \frac{1}{{N}_{S}} {\sum }_{( x , y ) ∈ S} f ( [ x , ] ) ) \qquad ( 1 )$$

where f and g represent feedforward networks, and [⋅ , ⋅ ] represents concatenation of elements.

Note that, in above Expression (1), the average of f([x,y]) is input into g, but the present embodiment is not limited thereto, and for example, the sum or the maximum value of f([x,y]) may be input into g, or a vector obtained by inputting all of f([x,y]) to a recursive neural network, an attention mechanism, or the like may be input into g. That is, it can be assumed that an output of any function that outputs one vector on the assumption that a set of f([x,y]) is an input is the input of g (this means that all of f([x,y]) is aggregated into one vector by the function).

The score calculation unit 103 calculates an anomaly score for a certain feature amount vector x by a neural network using the task vector r, the support set S, and the feature amount vector x. Note that the anomaly score is a score representing degree of anomaly of a feature amount vector.

First, the score calculation unit 103 nonlinearly transforms the feature amount vector x by following Expression (2) using the task vector r and a neural network φ.

[Math. 4]

ϕ([x,r]) (2)

Next, the score calculation unit 103 calculates, as an anomaly score, a distance between a vector obtained by linearly projecting the nonlinearly transformed feature amount vector φ([x,r]) by above Expression (2) and a vector obtained by linearly projecting a preset center vector c. That is, the score calculation unit 103 calculates an anomaly score a(x|S) by following Expression (3):

[Math. 5]

α(x|S)=∥ŵ^{T}ϕ([x,r])−ŵ^{T}c∥² (3)

where \hat{ }w (to be exact, the symbol “\hat{ }” is written right above w, but in the text of the description, the symbol “\hat{ }” is added before w and written as “\hat{ }w”) is a linear projection vector. The linear projection vector is calculated such that the center is as far as possible from anomalous data included in a support set (that is, data of the label y=1) and the center is as close as possible to normal data included in the support set (that is, data of the label y=0). For example, the linear projection vector \hat{ }w can be calculated by following Expression (4):

$$[ Math . 6 ]$$

$$\begin{matrix}\hat{w} = arg {max}_{w} \frac{\frac{1}{{N}_{A}} {\sum }_{x ∈ {S}_{A}} a ( x \vert S )}{\frac{1}{{N}_{N}} {\sum }_{x ∈ {S}_{N}} a ( x \vert S ) + η {‖ w ‖}^{2}} \\ = arg {max}_{w} \frac{tr ( {w}^{⊤} {r}_{A} w )}{tr ( {w}^{⊤} {r}_{N} w )}\end{matrix} \qquad ( 4 )$$

where S_{A}={x|y=1,(x,y)∈S} is a set of anomalous data included in the support set S (hereinafter, referred to as an “anomalous support set”), N_{A} is the size of the anomalous support set, S_{N}={x|y=0,(x,y)∈S} is a set of normal data included in the support set S (hereinafter, referred to as a “normal support set”), N_{N} is the size of the normal support set, and η is a parameter. Furthermore, r_{A} and r_{N} are defined as follows:

$$[ Math . 7 ]$$

$${r}_{A} = \frac{1}{{N}_{A}} {\sum }_{x ∈ {S}_{A}} ( ϕ ( [ x , r ] ) - c ) {( ϕ ( [ x , r ] ) - c )}^{⊤} \\ {r}_{N} = \frac{1}{{N}_{N}} {\sum }_{x ∈ {S}_{N}} ( ϕ ( [ x , r ] ) - c ) {( ϕ ( [ x , r ] ) - c )}^{⊤} + η I$$

An optimization problem presented in above Expression (4) can be calculated by a generalized eigenvalue problem being solved. That is, it can be calculated by solving the following expression:

r_{A}ŵ=λr_{N}ŵ [Math. 8]

where λ is a maximum eigenvalue, and \hat{ }w is its eigenvector. Note that, in a case where there is one item of anomalous data (it is assumed that the anomalous data is x_{A}), \hat{ }w can also be calculated by solving the following optimization problem:

ŵ∝r_{N}⁻¹(ϕ([x_{A},r])−c) [Math. 9]

On the other hand, in a case where a label representing anomaly is not given or in a case where anomalous data is not given, the linear projection vector \hat{ }w is learned so as to make the anomaly score of given data smaller. For example, the linear projection vector \hat{ }w is learned by the following expression:

$$[ Math . 10 ]$$

$$\hat{w} = arg {min}_{w} \frac{1}{{N}_{N}} {\sum }_{x ∈ {S}_{N}} a ( x \vert S ) + η {‖ w ‖}^{2}$$

Furthermore, in a case where both labeled data and unlabeled data are given, the unlabeled data is weighted and regarded as normal data, and the linear projection vector \hat{ }w is learned so as to make the weighted anomaly score of given data smaller. For example, the linear projection vector \hat{ }w is learned by the following expression:

$$[ Math . 11 ]$$

$$\hat{w} = arg {max}_{w} \frac{\frac{1}{{N}_{A}} {\sum }_{x ∈ {S}_{A}} a ( x \vert S )}{\frac{1}{{N}_{N}} {\sum }_{x ∈ {S}_{N}} a ( x \vert S ) + λ \frac{1}{{N}_{U}} {\sum }_{x ∈ {S}_{U}} a ( x \vert S ) + η {‖ w ‖}^{2}}$$

where λ is a weight parameter, S_{U} is a set of the unlabeled data among data included in the support set S (hereinafter, referred to as an “unlabeled data set”), and N_{U} is the size of the unlabeled data set.

After sampling the task t from the task set {1, . . . , T} using the set D of training data sets received as input by the input unit 101, the learning unit 104 samples the support set S and the query set Q from the data set Dₜ. Note that the size of the support set S is preset. Similarly, the size of the query set Q is preset. Furthermore, in sampling, the learning unit 104 may perform sampling randomly, or may perform sampling according to a certain preset distribution.

Then, the learning unit 104 updates (learns) a parameter Θ of the anomaly detection model so as to make the anomaly detection performance higher by using the support set S and the query set Q. That is, the learning unit 104 learns the parameter Θ so as to make the expectation value indicated in the following Expression (5) (that is, a generalized performance expectation value of anomaly detection for the query set Q in a case where the support set S is given) higher.

[Math. 12]

[symbol]

_{t˜{1, . . . , T}}[ [symbol] _{S,} [symbol] _{)˜} [symbol] _{ₜ}[L( [symbol] |S;Θ)]] (5)

where Θ is a parameter of the anomaly detection model, and includes parameters of neural networks f, g, and φ. L(Q|S;Θ) is an index representing generalized performance of anomaly detection for the query set Q in a case where the support set S is given. As L(Q|S;Θ), for example, any index correlated with anomaly detection performance, such as an area under an ROC curve (AUC), an approximate AUC, a negative cross entropy error, and a log likelihood, can be used. In a case where an approximate AUC is used, L(Q|S;Θ) is represented by following Expression (6):

$$[ Math . 13 ]$$

$$L ( Q \vert S ; Θ ) = \frac{1}{{N}_{A}^{Q} {N}_{N}^{Q}} {\sum }_{x ∈ {Q}_{A}} {\sum }_{{x}^{′} ∈ {Q}_{N}} σ ( a ( x \vert S ) - a ( {x}^{′} \vert S ) ) \qquad ( 6 )$$

where σ is a sigmoid function, Q_{A} is a set of anomalous data included in the query set Q, N^{Q}_{A} is the size of Q_{A}, Q_{N} is a set of anomalous data included in the query set Q, and N^{Q}_{N} is the size of Q_{N}.

### Flow of Learning Processing

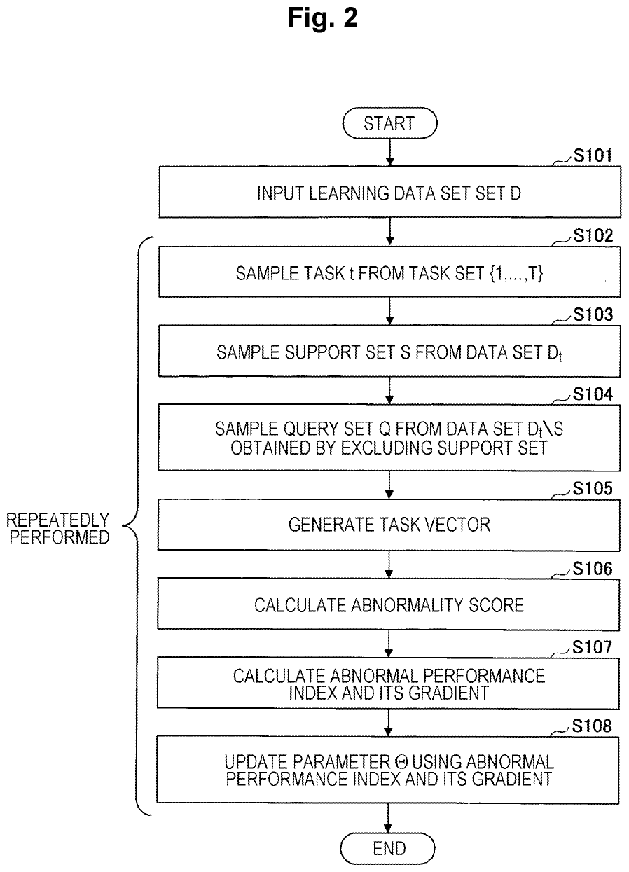

Next, a flow of learning processing performed by the learning apparatus 10 according to the present embodiment will be described with reference to FIG. 2. FIG. 2 is a flowchart illustrating an example of the flow of the learning processing according to the present embodiment. Note that it is assumed that the parameter Θ to be learned stored in the storage unit 105 is initialized using a known method (for example, initialized randomly, initialized according to certain distribution, or the like).

First, the input unit 101 receives as input a set D of training data sets stored in the storage unit 105 (step S101).

Subsequent steps S102 to S108 are repeatedly performed until a predetermined termination condition is satisfied. The predetermined termination condition is, for example, convergence of a parameter to be learned, execution of the repetition for a predetermined number of times, or the like.

The learning unit 104 samples a task t from a task set {1, . . . , T} (step S102).

Next, the learning unit 104 samples a support set S from a data set Dₜ of the task t sampled in above step S102 (step S103).

Next, the learning unit 104 samples a query set Q from a set obtained by excluding the support set S from the data set Dₜ (that is, a set of data not included in the support set S among data included in the data set Dₜ) (step S104).

Subsequently, the task vector generation unit 102 generates a task vector r representing the property of the task t corresponding to the support set S (that is, the task t sampled in above step S102) using the support set S sampled in above step S104 (step S105). For example, the task vector generation unit 102 generates the task vector r by above Expression (1).

Next, the score calculation unit 103 calculates anomaly scores a(x|S) of each of feature amount vectors included in the support set S sampled in above step S104 using the support set S sampled in above step S103 and the task vector r generated in above step S105 (step S106). That is, for example, the score calculation unit 103 nonlinearly transforms, for each of the feature amount vectors x included in the query set Q, the feature amount vectors x into φ([x,r]) by above Expression (2), and then calculates anomaly scores a(x|S) by above Expression (3). As a result, the anomaly scores a(x|S) for each of the feature amount vectors x included in the query set Q are calculated.

Next, the learning unit 104 calculates a value of an anomalous performance index L(Q|S;Θ) and its gradient related to the parameter Θ using the anomaly scores a(x|S) calculated in above step S106 (step S107). For example, the learning unit 104 may calculate an anomalous performance index L(Q|S;Θ) by above Expression (6). Furthermore, the gradient related to the parameter Θ may be calculated by a known method such as an error back propagation method.

Then, the learning unit 104 updates the parameter Θ to be learned using the anomalous performance index value and its gradient calculated in above step S107 (step S108). Note that the learning unit 104 may update the parameter Θ to be learned by a known update expression or the like.

By anomaly, the learning apparatus 10 according to the present embodiment can learn the parameter Θ of the anomaly detection model implemented by the task vector generation unit 102 and the score calculation unit 103. Note that, in testing, a support set and a query of a target task may be received as input by the input unit 101, to generate a task vector from the support set, and then calculate an anomaly score from the task vector and the query. If the anomaly score is greater than or equal to a predetermined threshold, the query is determined to be anomalous data, and if not, the query is determined to be normal data. The learning apparatus 10 in testing may not include the learning unit 104, and may be referred to as, for example, an “anomaly detection apparatus” or the like.

### Evaluation Result

Next, evaluation results of the anomaly detection model learned by the learning apparatus 10 according to the present embodiment will be described. In the present embodiment, the anomaly detection model was evaluated using known anomaly detection data. As the evaluation result, a test AUC is illustrated in following Table 1:

TABLE 1

| Ours | MAML | FT | OSVM | RF |
|---|---|---|---|---|
| 0.913 | 0.727 | 0.834 | 0.811 | 0.704 |

where Ours is the anomaly detection model learned by the learning apparatus 10 according to the present embodiment. As existing methods to be compared, model-agnostic meta-learning (MAML), fine-tuning (FT), one-class support vector machine (OSVM), and random forest (RF) are used.

As illustrated in above Table 1, the anomaly detection model learned by the learning apparatus 10 according to the present embodiment achieves a high anomaly detection performance as compared with the existing methods.

As described above, the learning apparatus 10 according to the present embodiment can learn an anomaly detection model of a target task from a set of data sets of a plurality of anomaly detection tasks, and by this anomaly detection model, high anomaly detection performance can be implemented even in a case where only a small amount of training data is given to the target task.

### Hardware Configuration

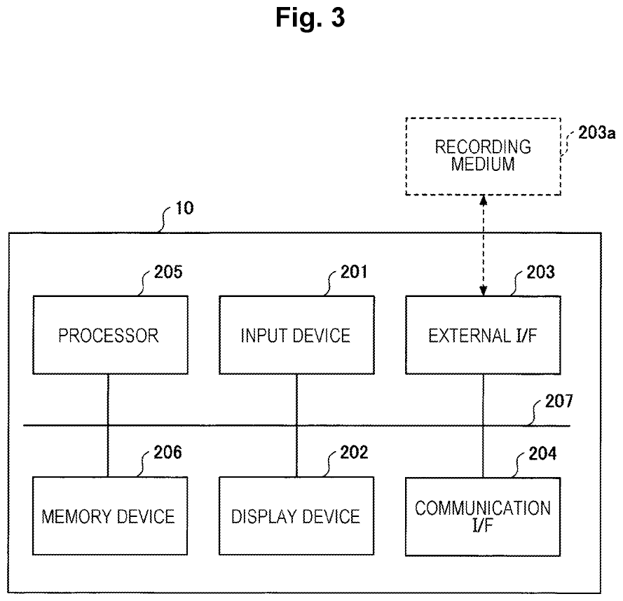

Finally, a hardware configuration of the learning apparatus 10 according to the present embodiment will be described with reference to FIG. 3. FIG. 3 is a diagram illustrating an example of the hardware configuration of the learning apparatus 10 according to the present embodiment.

As illustrated in FIG. 3, the learning apparatus 10 according to the present embodiment is implemented by a general computer or a computer system, and includes an input device 201, a display device 202, an external interface (I/F) 203, a communication I/F 204, a processor 205, and a memory device 206. These hardware components are communicably connected via a bus 207.

The input device 201 is, for example, a keyboard, a mouse, a touch panel, or the like. The display device 202 is, for example, a display or the like. Note that the learning apparatus 10 may not include at least one of the input device 201 and the display device 202.

The external I/F 203 is an interface with an external device such as a recording medium 203a. The learning apparatus 10 can, for example, read from and write onto the recording medium 203a via the external I/F 203. The recording medium 203a may store, for example, one or more programs for implementing each of the functional unit (the input unit 101, the task vector generation unit 102, the score calculation unit 103, and the learning unit 104) included in the learning apparatus 10. Note that the recording medium 203a is, for example, a compact disc (CD), a digital versatile disk (DVD), a secure digital memory card (SD memory card), a universal serial bus (USB) memory card, or the like.

The communication I/F 204 is an interface for connecting the learning apparatus 10 to a communication network. Note that one or more programs for implementing each functional unit included in the learning apparatus 10 may be acquired (downloaded) from a predetermined server device or the like via the communication I/F 204.

The processor 205 is, for example, an arithmetic/logic device among various types such as a central processing unit (CPU) and a graphics processing unit (GPU). Each of the functional unit included in the learning apparatus 10 is implemented, for example, by processing in which one or more programs stored in the memory device 206 are performed by the processor 205.

The memory device 206 is, for example, a storage device among various types such as a hard disk drive (HDD), a solid state drive (SSD), a random access memory (RAM), a read only memory (ROM), and a flash memory. The storage unit 105 included in the learning apparatus 10 is implemented by, for example, the memory device 206. However, the storage unit 105 may be implemented by, for example, a storage device (for example, a database server or the like) connected to the learning apparatus 10 via a communication network.

The learning apparatus 10 according to the present embodiment can implement the above-described learning processing by having the hardware configuration illustrated in FIG. 3. Note that the hardware configuration illustrated in FIG. 3 is an example, and the learning apparatus 10 may have another hardware configuration. For example, the learning apparatus 10 may include a plurality of processors 205 or may include a plurality of memory devices 206.

The present invention is not limited to the above-mentioned specifically disclosed embodiment, and various modifications and changes, combinations with known technique, and the like can be made without departing from the scope of the claims.

### Reference Signs List

10 Learning apparatus
101 Input unit
102 Task vector generation unit
103 Score calculation unit
104 Learning unit
105 Storage unit
201 Input device
202 Display device
203 External I/F
203a Recording medium
204 Communication I/F
205 Processor
206 Memory device
207 Bus

1. A learning method executed by a computer including a memory and a processor, the learning method comprising:
receiving as input a set of data sets D={D₁, . . . , D_{T}} wherein a task set is {1, . . . , T} and a data set including data at least including feature amount vectors representing features of cases of a task t∈{1, . . . , T} is denoted as Dₜ;
sampling a task t from the task set {1, . . . , T}, and sampling a first subset from a data set Dt of the task t and a second subset from a set obtained by excluding the first subset from the data set Dt;
generating a task vector representing a property of a task t corresponding to the first subset by a first neural network;
nonlinearly transforming feature amount vectors included in data included in the second subset by a second neural network using the task vector;
calculating scores representing respective degrees of anomaly of the feature amount vectors using the nonlinearly transformed feature amount vectors and a preset center vector; and
learning a parameter of the first neural network and a parameter of the second neural network so as to make an index value representing generalized performance of anomaly detection higher using the scores.

2. The learning method according to claim 1,
wherein the first neural network includes a first feedforward neural network and a second feedforward neural network, and
wherein the generating includes generating the task vector by generating a vector in which each item of data included in the first subset is aggregated by the first feedforward neural network, and then converting the generated vector by the second feedforward neural network.

3. The learning method according to claim 1,
wherein the calculating of the score includes calculating a distance between values obtained by linearly projecting the nonlinearly transformed feature amount vectors using a linear projection vector \hat{ }w and a value obtained by linearly projecting the center vector using the linear projection vector \hat{ }w as the scores.

4. The learning method according to claim 3,
wherein the linear projection vector \hat{ }w is a vector calculated such that a distance between anomalous data among data included in the first subset and the center vector is as long as possible, and a distance between normal data among data included in the first subset and the center vector is as short as possible.

5. The learning method according to claim 1,
wherein the learning learns the parameter of the first neural network and the parameter of the second neural network so as to make the index value higher, by using as the index value, any one of an AUC, an approximate AUC, a negative cross entropy error, or a log likelihood.

6. A learning apparatus comprising:
a memory; and
a processor configured to execute:
receiving as input a set of data sets D={D1, . . . , DT} wherein a task set is {1, . . . , T} and a data set including data at least including feature amount vectors representing features of cases of a task t∈{1, . . . , T} is denoted as Dt;
sampling a task t from the task set {1, . . . , T}, and sampling a first subset from a data set Dt of the task t and a second subset from a set obtained by excluding the first subset from the data set Dt;
generating a task vector representing a property of a task t corresponding to the first subset by a first neural network;
nonlinearly transforming feature amount vectors included in data included in the second subset by a second neural network using the task vector;
calculating scores representing respective degrees of anomaly of the nonlinearly transformed feature amount vectors using the feature amount vectors and a preset center vector; and
learning a parameter of the first neural network and a parameter of the second neural network so as to make an index value representing generalized performance of anomaly detection higher using the scores.

7. A non-transitory computer-readable recording medium having computer-readable instructions stored thereon, which when executed, cause a computer to perform the learning method according to claim 1.
